(19) United States
(12) Patent Application Publication
(10) Pub. No.: US 2020/0242848 A1
(43) Pub. Date: Jul. 30, 2020

(54) DYNAMIC AUGMENTED REALITY HEADSET SYSTEM

(71) Applicant: Rhodan Marine Systems of Florida, LLC, Sarasota, FL (US)

(72) Inventors: Lindsay Ambler, Myakka City, FL (US); Glen Robertson, Sarasota, FL (US); John Miller, Bradenton, FL (US); Charles Murphy, Sarasota, FL (US)

(21) Appl. No.: 16/850,931

(22) Filed: Apr. 16, 2020

Related U.S. Application Data
(63) Continuation of application No. PCT/US2018/062848, filed on Nov. 28, 2018.
(60) Provisional application No. 62/593,347, filed on Dec. 1, 2017.

(51) Int. Cl. G06T 19/00; G02B 27/01; G01S 15/89; H04N 13/344; G02B 27/00

(52) U.S. Cl. CPC G06T 19/006; G02B 27/017; G02B 2027/0178; H04N 13/344; G02B 27/0093; G01S 15/8993

(57) ABSTRACT

An improved augmented reality (A/R) headset system is described. The system can feature a position sensor to determine a user's real-world view, an environmental sensor to determine objects obstructed from the real-world view, and a processing unit to correlate the data such that a merged graphical image corresponds to the user's real-world view. For example, the image can be a representation of objects that are obstructed in the user's real-world view. In addition, the image can be dynamic and change as the real-world view of the user changes, as the user rotates his head. In some instances, the position sensor includes an accelerometer, a magnetometer, a gyroscope, and/or a GPS device and the environmental sensor collects sonar data.

### CROSS-REFERENCE TO RELATED APPLICATION

This application claims priority to co-pending U.S. provisional patent application Ser. No. 62/593,347, titled “Dynamic Augmented Reality System,” filed on Dec. 1, 2017, the disclosure of which is herein incorporated by reference in its entirety.

### TECHNICAL FIELD

The invention relates generally to an augmented reality system and, more particularly, to an augmented reality headset that merges a graphical representation of an obstructed object with a user's real-world view.

### BACKGROUND

Augmented reality (A/R) systems in which a graphical image is superimposed over a user's real-world view are known. Commonly cited examples include Alphabet's Google Glass® product, Microsoft's HoloLens® product, and Nintendo's Pokémon GO!® game. Conventional A/R systems typically include a display worn by the user (e.g., a headset or pair of glasses) or in some cases held by the user (e.g., a smartphone) that presents the superimposed graphical image. The superimposed graphical image can take many forms, but in most instances it conveys some item of information to the user that is not available from the user's natural real-world view. As a few examples, the graphical image can include (i) navigation instructions for a person driving a car (e.g., so that the driver can keep their eyes on the road without needing to look at the screen of a GPS device), (ii) health information (e.g., heartrate, pulse, etc.) for a person exercising, (iii) graphical representations of the human body (e.g., to facilitate training doctors) or other items, such as a car engine (e.g., to facilitate training auto mechanics). In addition, conventional A/R headsets can facilitate video game play, e.g., by presenting characters and other objects over the user's real-world view.

### SUMMARY

While current A/R systems represent a powerful technological advancement, the graphical images they display are generally limited to artificial items that are not closely related to objects existing in the real world. Thus, there is still a need for a system that detects information about real objects within a user's environment (e.g., hidden or obstructed objects) and uses an A/R graphical image to identify the object for the user. Accordingly, the present disclosure describes an improved A/R system that is able to detect the presence of and/or information about real objects within a user's environment (e.g., hidden or obstructed objects) and identify these objects and/or information related to these objects using an A/R overlaid graphical image. This is different from conventional A/R headsets that present a graphical image that is wholly independent of the user's real-world view (e.g., a temperature gauge, a heartrate monitor, etc.).

One environment in which such a system is useful is for recreational or professional fishing. The fish that fisherman seek to catch are located within a submarine environment that is typically obstructed from the fisherman's view by reflections off the surface of the water or murkiness of the water. Various technology exists for detecting the presence of fish and other objects under the surface of the water, e.g., sonar technology. Until now, however, this information has been displayed on a screen remote from the fisherman's view, often located away from the fishing deck (e.g., at the helm), which means that the fisherman needs to look away from the water and maybe even leave his position in order to receive the information. Embodiments of the present invention solve this problem by utilizing technology that allows detection of hidden objects (e.g., sonar sensors) with a heads up A/R display that presents a graphical image of the hidden objects onto a user's real-world view. In the fisherman example, a graphical image of fish can be overlaid over the user's real-world view of the surface of water at specific locations where fish are detected below the surface. This permits the fisherman to cast directly at the visualized fish.

For purposes of illustration, the application will often describe the invention within the context of an A/R system that displays the presence of obstructed submarine objects such as fish. However, the invention is broader than this particular example and can be used to overlay graphical images of many other obstructed objects in other environments, as well. In general, the invention relates to any system that can overlay a graphical image of any obstructed object within a user's real-world view. A non-exhaustive list of obstructed objects that can be shown with a graphical overlay includes: pipes located underground or within a wall, items in subterranean environments (e.g., as may be explored by a metal detector), an interior environment of the human body, etc.

In one aspect, the invention relates to an augmented reality system. The system can include a wearable heads up display device, a position sensor mounted on the heads up display and adapted to collect position data related to a real-world view of a user, an environmental sensor adapted to collect environmental data to identify at least one obstructed object in the real-world view, and a processing unit adapted to merge an image comprising a representation of the obstructed object with the real-world view.

In some embodiments of the above aspect, the heads up display device includes at least one of glasses and goggles. In some cases, the position sensor includes an accelerometer (e.g., a 3-axis accelerometer), a magnetometer (e.g., a 3-axis magnetometer), a gyroscope (e.g., a 3-axis gyroscope), and/or a GPS device. The environmental sensor can collect sonar data, subterranean environmental data, and/or submarine environmental data. In some cases, the environmental sensor is mounted remotely from the heads up display device. The processing unit can be further adapted to correlate the position data and the environmental data to change the image in real time. In some instances, the obstructed object is located in at least one of a subterranean environment and a submarine environment. The obstructed object can include a fish, a reef, and/or an inanimate object. At least a portion of the real-world view can include a water surface. In some cases, the processing unit is mounted on the heads up display. In other cases, the processing unit is located remote from the heads up display and the augmented reality system can further includes a wireless antenna adapted to communicate the position data and the environmental data to the processing unit. The representation of the obstructed object can include at least one of a pictogram, a topographic map, and a shaded relief map.

In another aspect, the invention relates to a method for displaying an augmented reality to a user. The method can include the steps of collecting position data related to a real-world view of the user, collecting environmental data to identify at least one obstructed object in the real world view, and merging an image comprising a representation of the obstructed object with the real-world view.

In some embodiments of the above aspect, the environmental data can include sonar data. In some cases, the obstructed object is located in at least one of a subterranean environment and/or a submarine environment. The obstructed object can include a fish, a reef, and/or an inanimate object. At least a portion of the real-world view can include a water surface. The representation of the obstructed object can include at least one of a pictogram, a topographic map, and a shaded relief map. In some instances, the method further includes correlating the position data and the environmental data to change the image in real time.

### BRIEF DESCRIPTION OF THE FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 depicts an example environment in which an A/R system is used, according to various embodiments of the invention;

FIG. 2 is a perspective view of an A/R headset, according to various embodiments of the invention;

FIG. 3 depicts a view presented to a user using the A/R system, according to various embodiments of the invention;

FIG. 4 depict a graphical overlay including a numerical icon, according to various embodiments of the invention;

FIG. 5 depicts a textual message graphical overlay, according to various embodiments of the invention;

FIG. 6 depicts additional graphical overlays, according to various embodiments;

FIG. 7 is a chart listing example minimum, maximum, and nominal parameter values for various features of the A/R system, according to various embodiments of the invention; and

FIG. 8 is a schematic diagram of a computing device that can be used in various embodiments of the invention.

### DETAILED DESCRIPTION

Embodiments of the present invention relate to an A/R system that merges images of obstructed objects with a user's real-world view. FIG. 1 depicts an example environment 100 in which the A/R system can be used. The environment 100 includes a user 102 (e.g., a fisherman) on a boat 104 above a water surface 106. The A/R system can include an environmental sensor 108 that determines aspects about the environment 100. For example, the environmental sensor 108 can determine the location of objects within the environment 100. The objects can be obstructed from the user's field of view. For example, the objects can be beneath the water surface 106. In general, any object can be detected. Examples include fish 110a-c, a reef 112, and/or other animate and inanimate object(s) 114. The environmental sensor 108 can use any known technique for determining the presence of objects. For example, the environmental sensor 108 can use sonar technology, similar to that used in conventional fish finder devices. In general, the sonar technology emits sound waves and detects or measures the waves reflected back after impinging on an object. The characteristics of the reflected waves can convey information regarding the size, composition, and/or shape of the object.

In various embodiments, the environmental sensor 108 can use other types of technology, in addition to or as an alternative from sonar technology. For example, the environmental sensor 108 can use traditional RADAR and ground penetrating RADAR technology. RADAR technology operates at a higher frequency signal than sonar, so it can provide images with greater resolution. In some cases, both traditional RADAR and ground penetrating RADAR can be used to detect surface obstructions and subsurface features. As another example, the environmental sensor 108 can use LIDAR technology, which also operates at a higher frequency than sonar and can produce high resolution images. In some cases, LIDAR technology can be used for high resolution bottom imaging in shallow waters. As another example, the environmental sensor 108 can include a scanning magnetometer, which can display magnetic anomalies to identify objects/features along a scanned surface (e.g., the bottom of a body of water). In other embodiments, rather than scanning the bottom of a body of water in real time, the features can be uploaded to the A/R system from a prerecorded map.

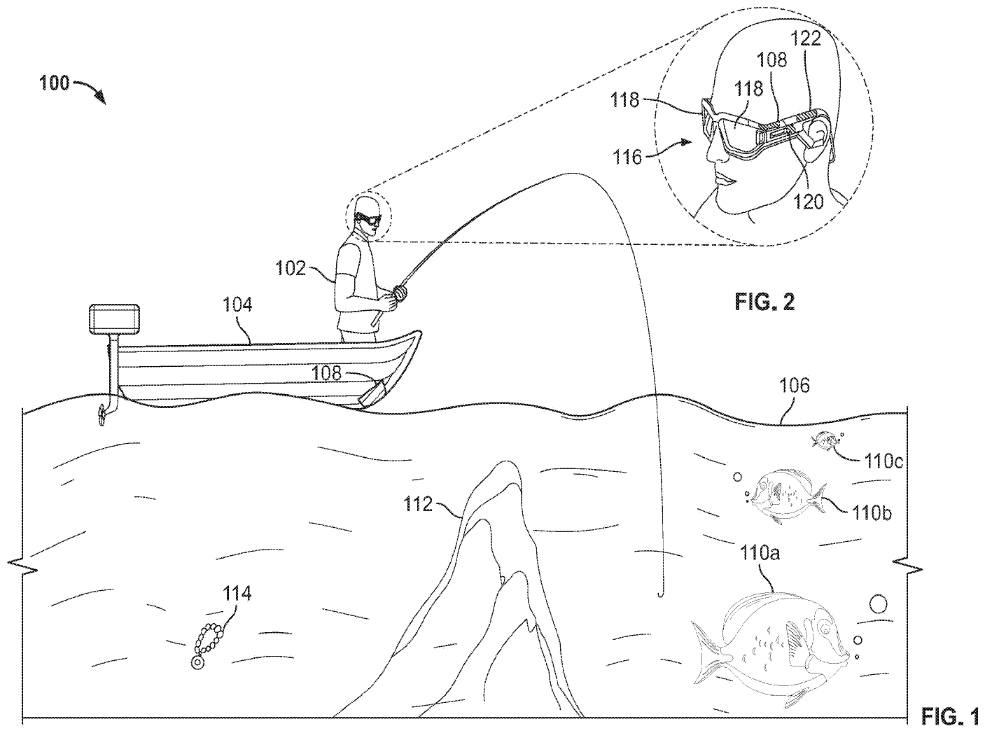

In some instances, as shown in FIG. 1, the environmental sensor 108 can be mounted to the boat 104. In addition, or as an alternative, the environmental sensor 108 can be part of a heads up display device 116 (e.g., a headset) worn by the user 102, an example of which is shown in FIG. 2. The environmental sensor 108 is not limited to detecting the presence of objects. In some instances, the environmental sensor 108 can determine characteristics of the object; for example, the object size, the object temperature, the object shape, etc. In still further instances, the environmental sensor 108 (or in some cases a separate sensor) can collect other types of environmental data. In general any type of measurable data can be collected. A non-exhaustive list of examples includes air temperature, water temperature, humidity, air purity, water purity, wind velocity, boat velocity, boat heading, etc.

FIG. 2 is a close up view of the headset 116 worn by the user 102. In general, the headset 116 can take any form of heads up display that results in a display being presented in front of at least one of the user's eyes. The heads up display can include any suitable support; for example, glasses, goggles, a helmet, a visor, a hat, a strap, a frame, etc. The example headset 116 shown in FIG. 2 is a pair of glasses that includes a display 118 disposed in front of each of the user's eyes. In other instances, a graphical image can be superimposed onto the user's real-world view without using the headset 116. For example, the graphical image can be generated from a projector mounted to the boat 104 or other structure and aimed such that the graphical image is presented within the user's real-world view.

In various embodiments, the A/R system includes a processing unit 120 in communication with the headset 116 (or remote projection system) that generates a graphical image that is presented to the user 102. The processing unit 120 can be located on the headset 116 (as shown in FIG. 2) or remotely from the headset 116 (e.g., in a portable computing device carried by the user, such as a smart phone, or in a computing device located on the boat 104). In some instances, the processing unit 120 can communicate with the environmental sensor 108 and/or the position sensor 122 via a wireless antenna. The graphical image can be based on data received from the environmental sensor 108. For example, when the environmental sensor 108 detects the presence of an object under the water surface 106, the processing unit 120 can cause a graphical image of the object to be presented to the user 102 in a corresponding location.

In some instances, the processing unit 120 can also receive data related to the real-world view of the user 102. For example, the processing unit 120 can be in communication with a position sensor 122 that determines the position of the user's head, from which the user's real-world view can be determined. The position sensor 122 can include any suitable sensor for measuring head position; for example, a GPS device, an accelerometer (e.g., a 3-axis accelerometer), a magnetometer (e.g., a 3-axis magnetometer), a gyroscope (e.g., a 3-axis gyroscope), a 9-axis motion sensor, and/or combinations thereof. As shown in FIG. 2, in some cases the position sensor 122 can be mounted to the headset 116. In other cases, the position sensor 122 can be remote from the headset 116. For example, the position sensor 122 can be mounted elsewhere on the user (e.g., on a belt) or to the boat 104 and can measure the head position and/or eye position using remote sensing techniques (e.g., infrared sensing, eye-tracking, etc.). In some embodiments, the system can be configured to determine the position (e.g., at least the heading) of the environmental sensor 108 in addition to the position of the user's head. This can be done using the same position sensor 122 that determines the position of the user's head or with a different position sensor. In some instances, knowing the position of both the user's head and the environmental sensor 108 can enable or simplify calibration of the data.

In some cases, the graphical image is generated based on data received from both the environmental sensor 108 and the position sensor 122. For example, in cases where the environmental sensor 108 determines the position of obstructed objects, the graphical image can include representations of objects that are obstructed from the user's current real-world view. The graphical images presented to the user 102 can change in real time as the user's real world view changes. For example, as the user 102 walks around the deck of the boat 104 or turns his head and the portions of the water surface 106 in his real world view change, the graphical image presented to the user 102 can also change. This functionality can advantageously include correlating the data received from the environmental sensor 108 and the position sensor 122. In some instances, the graphical projection can be an orthographic projection that is calculated based on a Euler technique, a Tait-Bryan angle technique, or another suitable technique.

In some instances, the images presented to the user 102 correlate in real-time to the data detected by the environmental sensor 108. In other instances, the images presented to the user 102 are based on prior data collected by the environmental sensor 108. This may be advantageous, for example, when the environmental sensor 108 itself is moving. As an example of this scenario, if the environmental sensor 108 is a sonar detector mounted under the hull of the boat 104, as the boat 104 moves, the terrain detected by the sensor 108 can also change. In such instances, if the user's real-world view includes an area that is not presently being detected by the environmental sensor 108 (e.g., behind the wake of the boat), then the images presented to the user 102 can be based on prior data collected by the environmental sensor 108. In such instances, the prior environmental data is stored in a memory or other storage device located locally on the headset 116 or remotely (e.g., in the cloud). In some embodiments, the data collected by the environmental sensor 108 can be mapped independent of the user's real-world view, e.g., with respect to the earth or another suitable frame of reference.

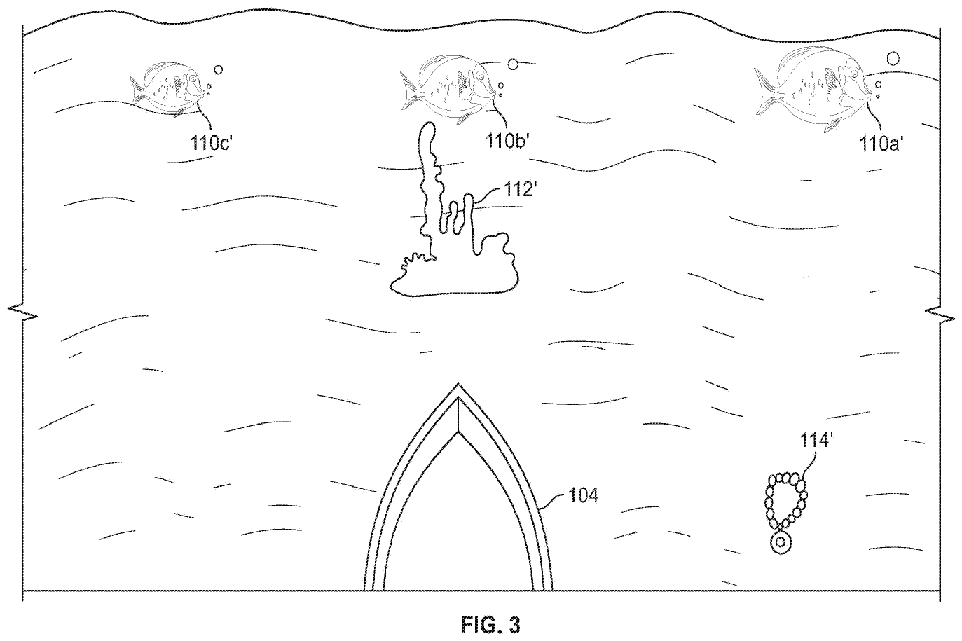

FIG. 3 is an example view presented to a user 102 wearing the headset 116 including graphical representations of objects beneath the water surface 106, that are obstructed from the user's real-world view. The reference numerals referring to the graphical representations in FIG. 3 correspond to the objects show in FIG. 1, but with a prime designation. In general, the graphical images can take any form. A non-exhaustive list of examples includes a pictogram, a cartoon, an image, a photograph, a textual message, an icon, an arrow, a symbol, etc. In some cases, the graphical image takes the form of the obstructed object. For example, as shown in FIG. 3, if the obstructed object is a fish the graphical image can be a pictogram of a fish of a common size or of a corresponding size. Similarly, if the obstructed object is a reef, the graphical image can depict a reef. In various embodiments, the graphical images can have varying levels of correlation to the obstructed object. For example, in some instances, different pictograms can be used to depict different types of fish (e.g. one pictogram for a bass and a different pictogram for a sunfish). In other cases, generic pictograms can be used for all fish or all objects. In some embodiments, the graphical image can be a graphical depiction of a subterranean or submarine floor surface (e.g., the ocean floor). The graphical depiction can be a map-like imagery in topographic, shaded relief, or other suitable form.

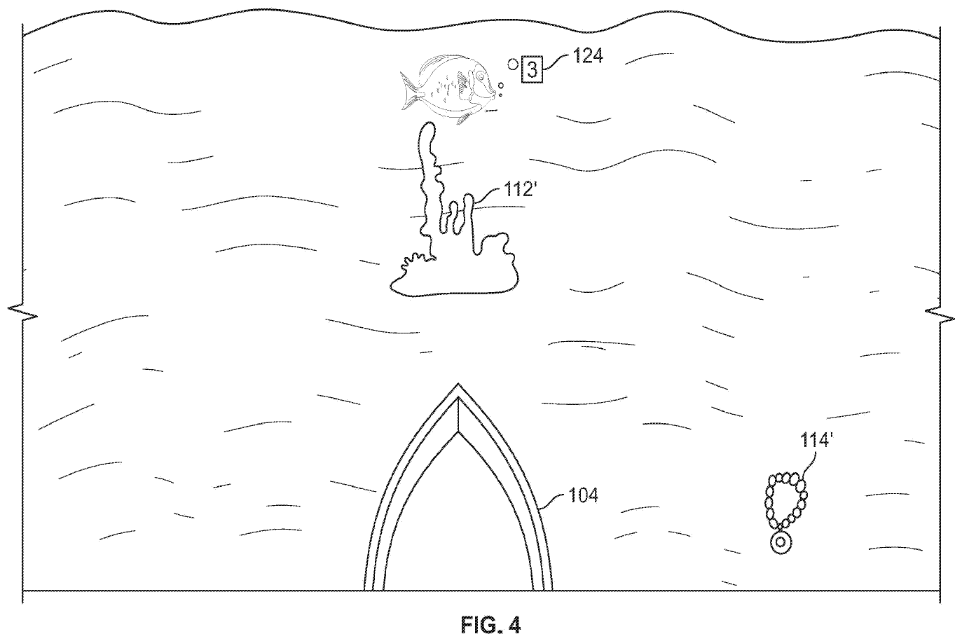

In various embodiments, the graphical depiction can convey additional information about the obstructed objects (e.g., additional information determined by the environmental sensor 108 or a different sensor). As one example, the graphical image can indicate the number of fish present. This can be done with a numerical icon 124 (see FIG. 4) if a particular number is determined (or estimated) or with various relative indicators (e.g., many fish, moderate amount of fish, small amount of fish). One example of a relative indicator can be an icon that displays differing colors depending on the number of fish present (e.g., yellow for a small amount, orange for a medium amount, and red for a large amount). Similar techniques can be used to convey an amount of other objects (e.g, reefs, inanimate objects, etc.).

In various instances, the graphical image can also convey information about the size of obstructed objects. As one example, the graphical depiction of a bigger fish (or other object) can be larger than the graphical depiction of a smaller fish (or other object). This concept is illustrated with reference to FIGS. 1 and 3. As shown in FIG. 1, fish 110a is larger than fish 110b which is larger than fish 110c; according, the graphical depiction 110a′ of fish 110a is larger than the graphical depiction 110b′ of fish 110b which is larger than the graphical depiction 110c′ of fish 110c. Other techniques can also be used to indicate the size of the detected object, for example; icons or relative indicators such as those described above for the amount of objects detected. Many additional types of information about the detected objects can also be conveyed using similar techniques.

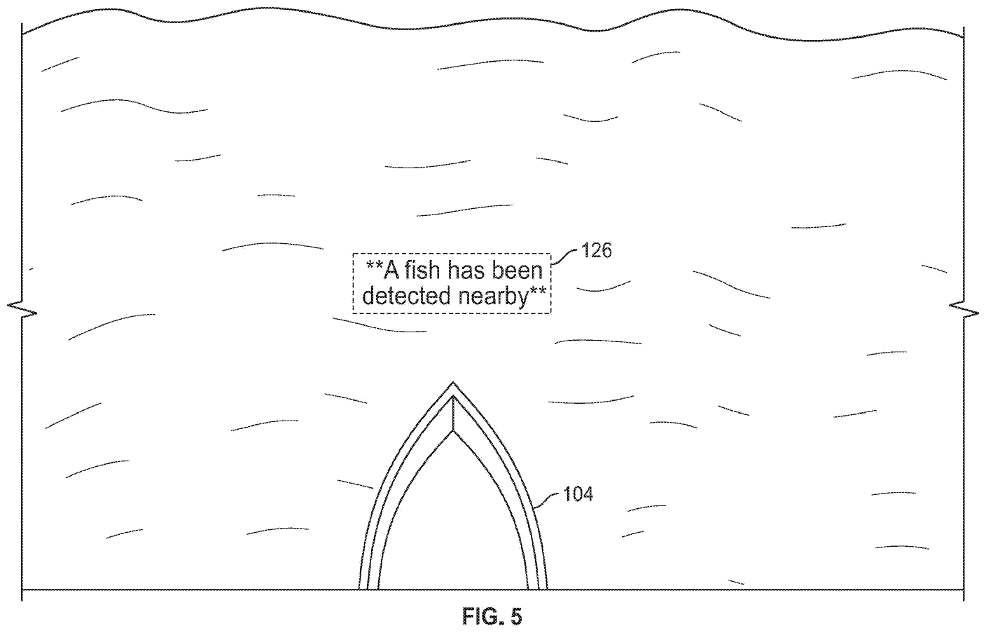

In other cases, the graphical image is generated based on data received from the environmental sensor 108, independent of the position sensor 122. For example, if the environmental sensor 108 detects the presence of a fish or other object, a graphical image can be superimposed over the user's real-world view indicating the detection, regardless of whether the detected objected is obstructed from the user's current real-world view. In general, the graphical depiction can be any graphic that alerts the user 102 to the detection, including the examples provided above, such as a pictogram, a textual message, or a symbol. For example, in this embodiment the graphical depiction can be a textual message 126 saying “A fish has been detected nearby” (see FIG. 5).

In some instances, the A/R system can feature various selectable modes. For example, in a first mode graphical images can be generated based on environmental data correlated with position data (e.g., such that a user is only presented a graphical image based on objects within or obstructed from the user's current real-world view); and in a second mode graphical images can be generated based on environmental data independent from position data (e.g., such that a user is presented with a graphical image if an object is detected by the environmental detector 108, regardless of whether it is within or obstructed from the user's current real-world view). In some cases, users may choose the second mode if they want to know if an object is detected anywhere around the boat 104. For example, if the user 102 is facing off the port side of the boat 104 and fish are detected off of the starboard side of the boat 104, the user can be presented with a graphical image indicating that fish have been detected nearby, with or without corresponding directional information.

In some embodiments, the system may enable both modes at once. For example, a user 102 may be presented a graphical image (e.g., a pictogram, etc.) indicating the location of a fish (or other object) that is obstructed from the user's current real-world view and also may be presented a graphical image (e.g., a textual message, symbol, etc.) if a fish (or other object) is detected outside of the user's current real-world view. Taking the above example of the user 102 facing off the port side of the boat 104, in such embodiments: (i) if a fish is detected off of the port side of the boat 104, the user 102 can be presented with a graphical image (e.g., a pictogram, etc.) showing the location of the fish; (ii) if a fish is detected off of the starboard side of the boat 104, the user 102 can be presented with a graphical image (e.g., a textual message, symbol, etc.) indicating that a fish is detected, but not within the user's current real-world view (in some cases, the graphical image can indicate the location where the fish is detected, e.g., with an arrow, text, etc.); and (iii) if the user 102 changes his real-world view to face off the starboard side of the boat, the user can then be presented with a graphical image (e.g., a pictogram, etc.) indicating the specific location of the fish.

In other instances, the system may offer only one mode or the other. For example, some systems may only offer the second mode, which in some cases may generate graphical images using less complex processing techniques, which may result in lower power consumption and/or more economical product offerings.

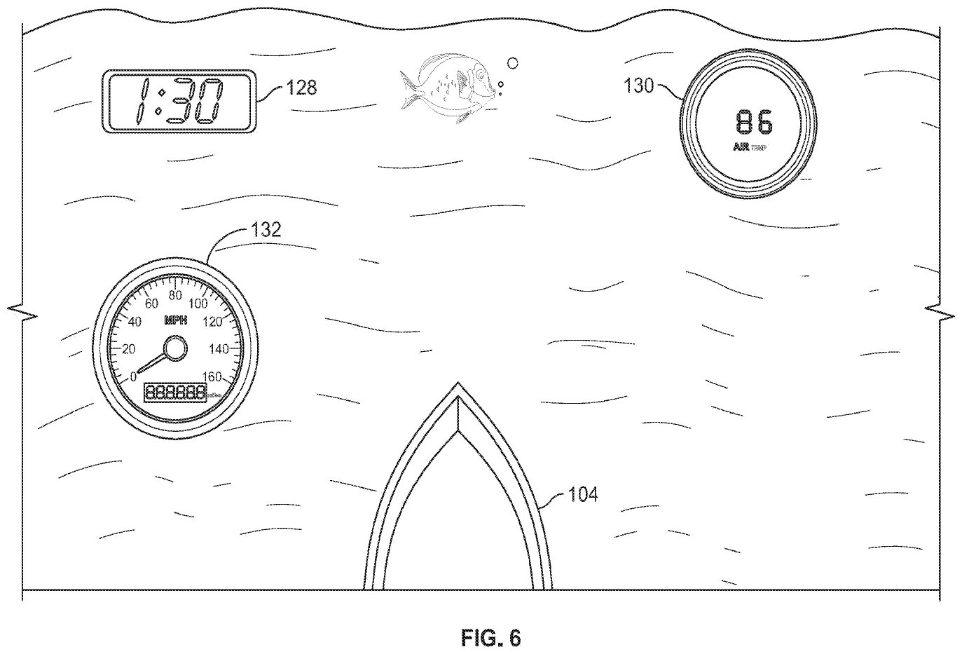

In other cases, the graphical image can be generated based on data received from neither the environmental sensor 108 nor the position sensor 122. As a few non-exhaustive examples, the graphical image can be a clock 128 displaying the time, a thermometer 130 displaying the temperature (e.g., air or water), a velocity gauge 132 (e.g., wind, the boat 104, etc.), etc., as shown in FIG. 6. Many other icons, gauges, instrument displays, etc. are possible. As another example, the graphical overlay can be a video stream, e.g., a live TV stream, a live stream from a remote recording device (e.g., from a different fishing location, boat dock, home, etc.). As another example, the graphical overlay can be an optical filter. e.g., to improve and/or enhance visibility. Many other examples of graphical overlays are possible.

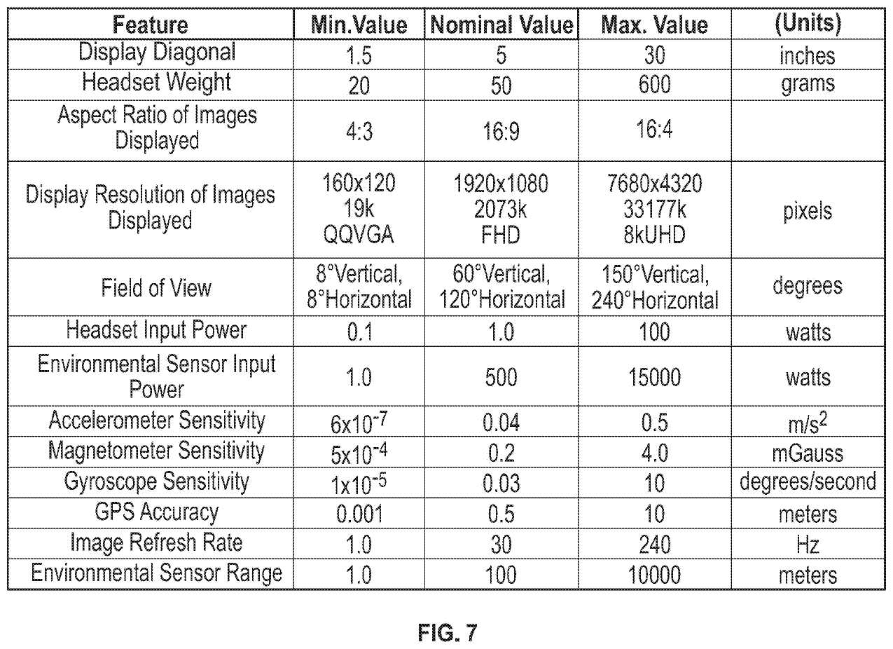

FIG. 7 is a chart listing example minimum, maximum, and nominal parameter values for various features of the A/R system.

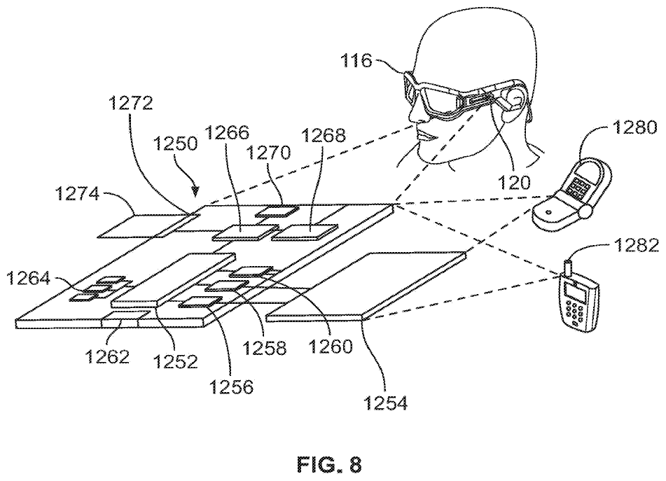

FIG. 8 shows an example of a generic computing device 1250, which may be used with the techniques described in this disclosure. For example, in some instances, the computing device 1250 can be the processing unit 120. The computing device 1250 includes a processor 1252, memory 1264, an input/output device such as a display 1254, a communication interface 1266, and a radio-frequency transceiver 1268, among other components. The computing device 1250 may also be provided with a storage device, such as a microdrive or other device, to provide additional storage. Each of the components 1252, 1264, 1254, 1266, and 1268 are interconnected using various buses, and several of the components may be mounted on a common motherboard or in other manners as appropriate.

The processor 1252 can execute instructions within the computing device 1250, including instructions stored in the memory 1264. The processor 1252 may be implemented as a chipset of chips that include separate and multiple analog and digital processors. The processor 1252 may provide, for example, for coordination of the other components of the computing device 1250, such as control of user interfaces, applications run by device 1250, and wireless communication by the computing device 1250.

The processor 1252 may communicate with a user through a control interface 1258 and a display interface 1256 coupled to the display 1254. The display 1254 may be, for example, a TFT LCD (Thin-Film-Transistor Liquid Crystal Display), an OLED (Organic Light Emitting Diode) display, or other appropriate display technology. The display interface 1256 may include appropriate circuitry for driving the display 1254 to present graphical and other information to a user. The control interface 1258 may receive commands from a user and convert them for submission to the processor 1252. In addition, an external interface 1262 may be provided in communication with the processor 1252, so as to enable near area communication of the computing device 1250 with other devices. The external interface 1262 may provide, for example, for wired communication in some implementations, or for wireless communication in other implementations, and multiple interfaces may also be used.

The memory 1264 stores information within the computing device 1250. The memory 1264 can be implemented as one or more of a computer-readable medium or media, a volatile memory unit or units, or a non-volatile memory unit or units. Expansion memory 1274 may also be provided and connected to device 1250 through an expansion interface 1272, which may include, for example, a SIMM (Single In Line Memory Module) card interface. Such expansion memory 1274 may provide extra storage space for the computing device 1250, or may also store applications or other information for the computing device 1250. Specifically, the expansion memory 1274 may include instructions to carry out or supplement the processes described above, and may also include secure information. Thus, for example, the expansion memory 1274 may be provided as a security module for the computing device 1250, and may be programmed with instructions that permit secure use of the computing device 1250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1264, the expansion memory 1274, the memory on processor 1252, or a propagated signal that may be received, for example, over the transceiver 1268 or the external interface 1262.

The computing device 1250 may communicate wirelessly through the communication interface 1266, which may include digital signal processing circuitry where necessary. The communication interface 1266 may in some cases be a cellular modem. The communication interface 1266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through the radio-frequency transceiver 1268. In addition, short-range communication may occur, using a Bluetooth, WiFi, or other transceiver (not shown). In addition, a GPS (Global Positioning System) receiver module 1270 may provide additional navigation- and location-related wireless data to the computing device 1250, which may be used as appropriate by applications running on the computing device 1250.

The computing device 1250 may also communicate audibly using an audio codec 1260, which may receive spoken information from a user and convert it to usable digital information. The audio codec 1260 may likewise generate audible sound for a user, such as through a speaker, e.g., in a handset of the computing device 1250. Such sound may include sound from voice telephone calls, may include recorded sound (e.g., voice messages, music files, etc.) and may also include sound generated by applications operating on the computing device 1250.

The computing device 1250 may be implemented in a number of different forms, as shown in FIG. 8. For example, the computing device 1250 may be implemented as the processing unit 120, which in some cases is located on the headset 116. The computing device 1250 may alternatively be implemented as a cellular telephone 1280, as part of a smartphone 1282, a smart watch, a tablet, a personal digital assistant, or other similar mobile device.

### Computing Environment

Implementations of the subject matter and the operations described in this specification can be implemented in digital electronic circuitry or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or can also be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data including, by way of example, a programmable processor, a computer, a system on a chip or multiple ones or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures such as web services and distributed computing and grid computing infrastructures.

A computer program (also known as a program, software, software application, script, or code) can be written in any form of programming language including compiled or interpreted languages and declarative or procedural languages, and it can be deployed in any form including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output The processes and logic flows can also be performed by, and apparatus can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a GPS receiver, or a portable storage device (e.g., a universal serial bus (USB) flash drive), to name just a few. Devices suitable for storing computer program instructions and data include all forms of non-volatile memory, media and memory devices including, by way of example, semiconductor memory devices, e.g., EPROM, EEPROM, and flash memory devices, magnetic disks, e.g., internal hard disks or removable disks, magneto-optical disks, and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. A touch screen display can be used. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification or any combination of one or more such back-end, middleware, or front-end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any embodiments or of what may be claimed, but rather as descriptions of features specific to particular implementations of particular embodiments. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be described in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Each numerical value presented herein is contemplated to represent a minimum value or a maximum value in a range for a corresponding parameter. Accordingly, when added to the claims, the numerical value provides express support for claiming the range, which may lie above or below the numerical value, in accordance with the teachings herein. Every value between the minimum value and the maximum value within each numerical range presented herein (including in the chart shown in FIG. 7) is contemplated and expressly supported herein, subject to the number of significant digits expressed in each particular range. Absent inclusion in the claims, each numerical value presented herein is not to be considered limiting in any regard.

The terms and expressions employed herein are used as terms and expressions of description and not of limitation and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The structural features and functions of the various embodiments may be arranged in various combinations and permutations, and all are considered to be within the scope of the disclosed invention. Unless otherwise necessitated, recited steps in the various methods may be performed in any order and certain steps may be performed substantially simultaneously. Accordingly, the described embodiments are to be considered in all respects as only illustrative and not restrictive. Furthermore, the configurations described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. An augmented reality system comprising:
a wearable heads up display device;
a position sensor mounted on the heads up display device and adapted to collect position data related to a real-world view of a user;
an environmental sensor adapted to collect environmental data to identify at least one obstructed object in the real-world view; and
a processing unit adapted to merge an image comprising a representation of the obstructed object with the real-world view.

2. The augmented reality system of claim 1, wherein the heads up display device comprises at least one of glasses and goggles.

3. The augmented reality system of claim 1, wherein the position sensor comprises at least one of an accelerometer, a magnetometer, a gyroscope, and a GPS device.

4. The augmented reality system of claim 1, wherein the environmental sensor collects sonar data.

5. The augmented reality system of claim 1, wherein the environmental sensor is mounted remotely from the heads up display device.

6. The augmented reality system of claim 1, wherein the environmental sensor collects at least one of subterranean environment data and submarine environment data.

7. The augmented reality system of claim 1, wherein the processing unit is further adapted to correlate the position data and the environmental data to change the image in real time.

8. The augmented reality system of claim 1, wherein the obstructed object is located in at least one of a subterranean environment and a submarine environment.

9. The augmented reality system of claim 8, wherein the obstructed object comprises at least one of a fish, a reef, and an inanimate object.

10. The augmented reality system of claim 9, wherein at least a portion of the real-world view comprises a water surface.

11. The augmented reality system of claim 1, wherein the processing unit is mounted on the heads up display device.

12. The augmented reality system of claim 1, wherein the processing unit is located remote from the heads up display device, and further comprising a wireless antenna adapted to communicate the position data and the environmental data to the processing unit.

13. The augmented reality system of claim 1, wherein the representation comprises at least one of a pictogram, a topographic map, and a shaded relief map.

14. A method for displaying an augmented reality to a user, the method comprising:
collecting position data related to a real-world view of the user;
collecting environmental data to identify at least one obstructed object in the real-world view; and
merging an image comprising a representation of the obstructed object with the real-world view.

15. The method of claim 14, wherein the environmental data comprises sonar data.

16. The method of claim 14, wherein the obstructed object is located in at least one of a subterranean environment and a submarine environment.

17. The method of claim 16, wherein the obstructed object comprises at least one of a fish, a reef, and an inanimate object.

18. The method of claim 17, wherein at least a portion of the real-world view comprises a water surface.

19. The method of claim 14, wherein the representation comprises at least one of a pictogram, a topographic map, and a shaded relief map.

20. The method of claim 14, further comprising correlating the position data and the environmental data to change the image in real time.
